(19) United States
(12) Patent Application Publication
(10) Pub. No.: US 2025/0246649 A1
(43) Pub. Date: Jul. 31, 2025

(54) FUEL CELL ACTIVATION APPARATUS

(71) Applicant: HONDA MOTOR CO., LTD., Tokyo (JP)

(72) Inventors: Ryo MOCHIZUKI, Saitama (JP); Ken TAGAWA, Saitama (JP)

(21) Appl. No.: 19/033,491

(22) Filed: Jan. 22, 2025

(30) Foreign Application Priority Data
Jan. 30, 2024 (JP) 2024-012155

(51) Int. Cl. H01M 8/04225; H01M 4/92; H01M 8/04223; H01M 8/04537; H01M 8/04746

(52) U.S. Cl. CPC H01M 8/04225; H01M 4/92; H01M 8/04231; H01M 8/04544; H01M 8/04753

(57) ABSTRACT

A fuel cell activation apparatus activates a fuel battery cell. The fuel cell activation apparatus includes a potential scanning circuit, anode side and cathode side gas supplies, and a controller. The potential scanning circuit applies a voltage to the fuel battery cell. The anode side gas supply supplies a fuel gas as a gas containing hydrogen to the anode layer. The cathode side gas supply supplies an inert gas as a gas containing nitrogen and not containing oxygen to the cathode layer. The controller controls the potential scanning circuit, the anode side gas supply, and the cathode side gas supply. The controller causes the anode side gas supply to supply the fuel gas to the anode layer and causes the cathode side gas supply to supply the inert gas to the cathode layer, while setting the cathode layer to a negative potential through the potential scanning circuit.

This application is based on and claims the benefit of priority from Japanese Patent Application No. 2024-012155, filed on 30 Jan. 2024, the content of which is incorporated herein by reference.

### BACKGROUND OF THE INVENTION

### Field of the Invention

The present invention relates to an apparatus for activating a fuel battery cell.

### Related Art

A certain type of fuel battery cell includes an anode layer, an electrolyte membrane, and a cathode layer in order from one side. The anode layer and the cathode layer contain platinum as a catalyst. Fuel gas as a gas containing a hydrogen is humidified and supplied to the anode layer. Oxidizing gas as a gas containing an oxygen is humidified and supplied to the cathode layer.

Once a load is connected to the fuel battery cell in this state, hydrogen ions dissociated from hydrogen molecules in the fuel gas pass through the electrolyte membrane to move to the cathode layer, and combine with oxygen atoms and electrons dissociated from oxygen molecules in the oxidizing gas to form water molecules. Power generation occurs through the series of events described above.
Patent Document 1: Japanese Unexamined Patent Application, Publication No. 20023-161181

### SUMMARY OF THE INVENTION

Typically, the performance of fuel battery cells such as those described above is inadequate immediately after manufacture thereof. Reasons therefor include, for example, contaminants adhering to the platinum and insufficiently wetted ionomers in an anode side catalyst layer, the electrolyte membrane, and a cathode side catalyst layer. Prior to shipment of fuel cell stacks, therefore, it is necessary to activate each of fuel battery cells therein. Methods for activating the fuel battery cell include a power generation method and a non-power generation method described below.

In the power generation method, the fuel gas and the oxidizing gas are humidified and supplied to the anode layer and the cathode layer, respectively, and a load is connected to the fuel battery cell to perform power generation. The power generation method activates the fuel battery cell by repeating potential sweep by controlling the current during the power generation, and washing away contaminants adhering to the platinum using ion flow and water produced in the course of the power generation. The power generation method also activates the fuel battery cell by supplying moisture in the fuel gas and the oxidizing gas, and the water produced in the course of the power generation to the anode layer, the electrolyte membrane, and the cathode layer, and thus wetting the cell.

By contrast, in the non-power generation method, the fuel gas is humidified and supplied to the anode layer, oxygen-free inert gas such as nitrogen is humidified and supplied to the cathode layer, and the potential is controlled using an external device. The non-power generation method does not supply oxidizing gas to the cathode layer, thereby advantageously keeping power output of the fuel battery cell at a low level compared to the power generation method. Since the fuel gas is supplied to the anode layer, moisture therein moves along with hydrogen ions moving through operation of a proton pump, and wets the cell. As such, the non-power generation method can activate the fuel battery cell through operation of a proton pump while keeping the power output of the fuel battery cell at a low level.

The non-power generation method allows for a reduction in equipment costs by keeping the power output at a low level. However, compared to the power generation method, the non-power generation method, when simply implemented, takes time to activate the fuel battery cell and is not so efficient in activating the fuel battery cell.

The present invention was made in view of the foregoing circumstances, and an object thereof is to efficiently activate a fuel battery cell by a non-power generation method.

The present inventors found that it is possible to efficiently activate a fuel battery cell by forcibly maintaining the cathode layer at a lower potential during operation of a proton pump, and thus arrived at the present invention.

A fuel cell activation apparatus according to the present invention activates a fuel battery cell including an anode layer, an electrolyte membrane, and a cathode layer in order from one side. The anode layer and the cathode layer contain platinum as a catalyst.

The fuel cell activation apparatus includes:
a potential scanning circuit configured to apply a voltage to the fuel battery cell;
an anode side gas supply configured to supply a fuel gas as a gas containing hydrogen to the anode layer;
a cathode side gas supply configured to supply an inert gas as a gas containing nitrogen and not containing oxygen to the cathode layer; and
a controller configured to control the potential scanning circuit, the anode side gas supply, and the cathode side gas supply.

The controller causes the anode side gas supply to supply the fuel gas to the anode layer and causes the cathode side gas supply to supply the inert gas to the cathode layer, while setting the cathode layer to a negative potential relative to the anode layer through the potential scanning circuit to maintain the cathode layer at a lower potential than when the controller does not set the cathode layer to a negative potential relative to the anode layer.

According to the present invention, the controller forcibly maintains the cathode layer at a lower potential by setting the cathode layer to a negative potential relative to the anode layer through the potential scanning circuit. Consequently, the platinum in the cathode layer is negatively charged to facilitate generation of repulsive force between the platinum and contaminants adhering thereto, so that the contaminants easily detach from the platinum.

The fuel gas is supplied to the anode layer and the inert gas is supplied to the cathode layer in such a state to cause a proton pump to operate. Water is carried along with the flow of ions caused by operation of the proton pump to wash away the contaminants suspended after having detached from the platinum. Thus, it is possible to efficiently activate the fuel battery cell.

As described above, the configuration of the present embodiment makes it possible to efficiently activate a fuel battery cell by setting the cathode layer to a negative potential relative to the anode layer during operation of a proton pump.

### BRIEF DESCRIPTION OF THE DRAWINGS

FIG. 1 is a schematic diagram illustrating a fuel cell activation apparatus according to a first embodiment;

FIG. 2 is a schematic diagram illustrating a fuel battery cell being activated by the fuel cell activation apparatus;

FIG. 3 is a graph showing transition of the potential of a representative site; and

FIG. 4 is a schematic diagram illustrating the fuel battery cell generating power.

### DETAILED DESCRIPTION OF THE INVENTION

The following describes an embodiment of the present invention with reference to the accompanying drawings. However, the present invention is not in any way limited to the following embodiment, and appropriate modifications can be made within the scope of the gist of the present invention to practice the present invention.

### First Embodiment

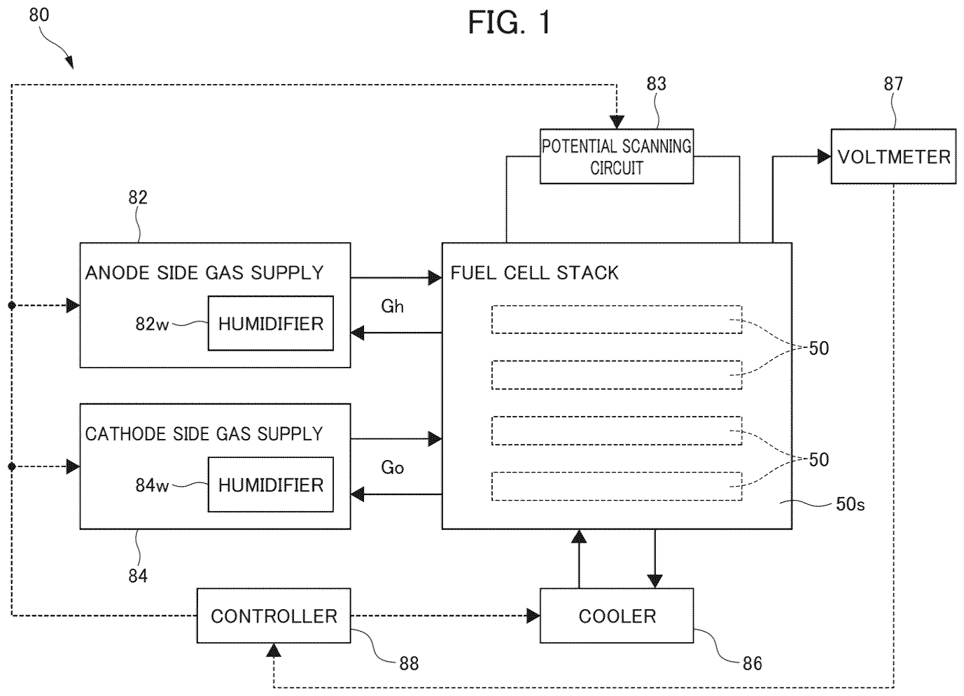

A fuel cell activation apparatus 80 shown in FIG. 1 is installed for a fuel cell stack 50s. A plurality of fuel battery cells 50 are contained in the fuel cell stack 50s.

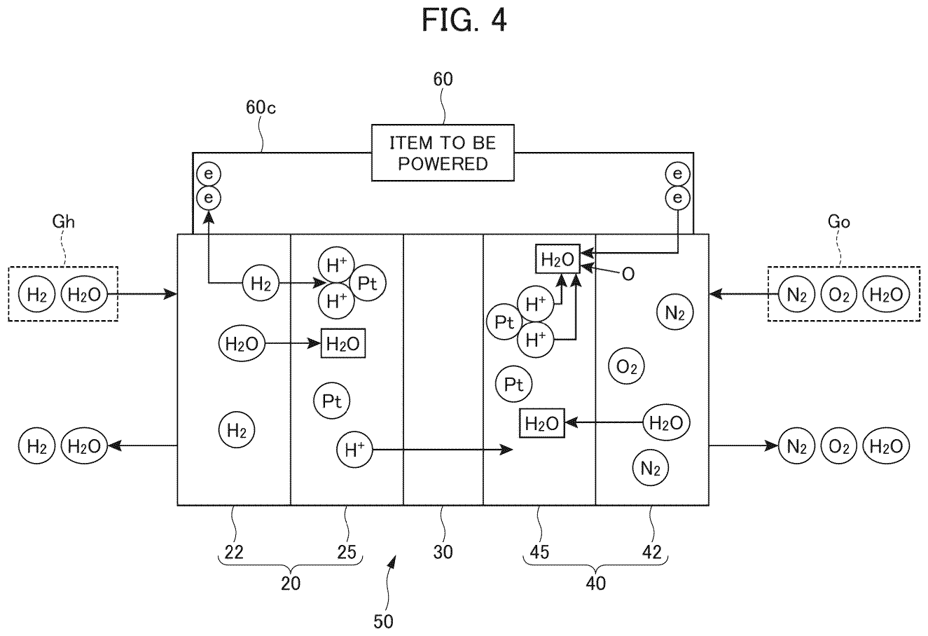

As shown in FIG. 4, each of the fuel battery cells 50 includes an anode layer 20, an electrolyte membrane 30, and a cathode layer 40 in order from one side. The anode layer 20 includes an anode side gas diffusion layer 22 and an anode side catalyst layer 25 located further toward the electrolyte membrane 30 than the anode side gas diffusion layer 22. The cathode layer 40 includes a cathode side gas diffusion layer 42 and a cathode side catalyst layer 45 located further toward the electrolyte membrane 30 than the cathode side gas diffusion layer 42. Both the anode side gas diffusion layer 22 and the cathode side gas diffusion layer 42 are mainly composed of porous layers. The anode side catalyst layer 25 and the cathode side catalyst layer 45 contain platinum Pt as a catalyst.

During power generation, the anode layer 20 and the cathode layer 40 are electrically connected to each other via a circuit 60c, which includes an item 60 to be powered. Hereinafter, hydrogen-containing gas is referred to as “fuel gas Gh” and oxygen-containing gas is referred to as “oxidizing gas Go”. It should be noted that the oxidizing gas Go as referred to herein is air, and contains nitrogen and oxygen. During power generation, the fuel gas Gh is humidified and supplied to the anode side gas diffusion layer 22, and the oxidizing gas Go is humidified and supplied to the cathode side gas diffusion layer 42.

Hydrogen molecules H₂ in the fuel gas Gh in the anode side gas diffusion layer 22 flows into the anode side catalyst layer 25, and dissociates into hydrogen ions H⁺ and electrons e. It should be noted that this reaction is catalyzed by the platinum Pt. The hydrogen ions H⁺ in the anode side catalyst layer 25 pass through the electrolyte membrane 30 to move to the cathode side catalyst layer 45. Hereinafter, the mechanism that causes this phenomenon is referred to as a “proton pump”. Meanwhile, the electrons e flow from the anode layer 20 side to the cathode layer 40 side in the circuit 60c.

The hydrogen ions H⁺ that have moved to the cathode side catalyst layer 45 combine with oxygen atoms O dissociated from oxygen molecules O₂ in the oxidizing gas Go in the cathode side gas diffusion layer 42 and the electrons e from the circuit 60c to form water molecules H₂O. The water molecules H₂O diffuse into the cathode side gas diffusion layer 42. Power generation occurs through the series of events described above.

In general, the performance of the fuel battery cells 50 described above is inadequate immediately after manufacture thereof. Reasons therefor include, for example, contaminants d adhering to the platinum Pt and insufficiently wetted ionomers in the anode side catalyst layer 25, the electrolyte membrane 30, and the cathode side catalyst layer 45. Prior to shipment of the fuel cell stack 50s, therefore, it is necessary to activate each of the fuel battery cells 50 therein. The fuel cell activation apparatus 80 shown in FIG. 1 is provided for such activation.

As shown in FIG. 1, the fuel cell activation apparatus 80 includes an anode side gas supply 82, a cathode side gas supply 84, a potential scanning circuit 83, a cooler 86, a voltmeter 87, and a controller 88. The anode side gas supply 82 and the cathode side gas supply 84 respectively include a humidifier 82w and a humidifier 84w that generate water vapor. The controller 88 controls the anode side gas supply 82, the cathode side gas supply 84, the potential scanning circuit 83, and the cooler 86.

The voltmeter 87 is configured to measure output voltage of each of the fuel battery cells 50. The output voltage of each fuel battery cell 50 measured by the voltmeter 87 is inputted to the controller 88.

The cooler 86 cools each fuel battery cell 50 by circulating a refrigerant between the fuel cell stack 50s and a radiator. The controller 88 controls the cooler 86 to control the temperature of each fuel battery cell 50 to a temperature that promotes the activation.

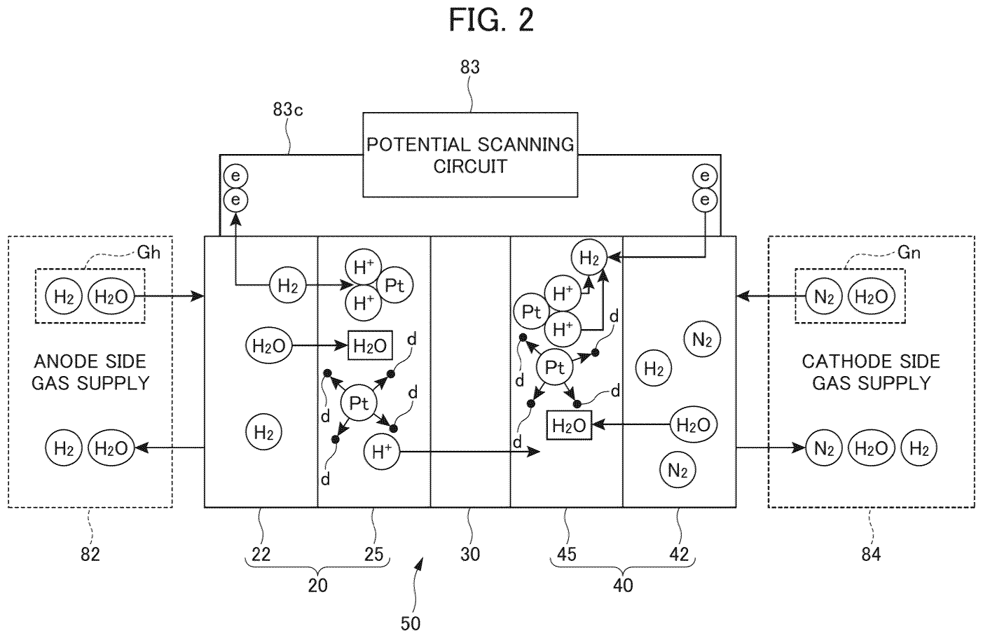

As shown in FIG. 2, the anode side gas supply 82 is configured to supply the fuel gas Gh humidified by the humidifier 82w to the anode side gas diffusion layer 22. The controller 88 controls the anode side gas supply 82 to control the flow rate and the pressure of the fuel gas Gh to be supplied to the anode layer 20.

Hereinafter, oxygen-free gas is referred to as “inert gas Gn”. Specifically, the inert gas Gn as referred to in the present embodiment is nitrogen N₂. The cathode side gas supply 84 is configured to supply the inert gas Gn humidified by the humidifier 84w to the cathode side gas diffusion layer 42. The controller 88 controls the cathode side gas supply 84 to control the flow rate and the pressure of the inert gas Gn to be supplied to the cathode layer 40.

The potential scanning circuit 83 includes, for example, a potentiostat. An electrode of the anode layer 20 is electrically connected to an electrode of the cathode layer 40 via a circuit 83c, which includes the potential scanning circuit 83. The potential scanning circuit 83 is configured to apply a voltage to the anode layers 20 and the cathode layers 40 from outside the fuel battery cells 50. Specifically, for example, the potential scanning circuit 83 controls the potential of the cathode layer 40 relative to the corresponding anode layer 20 by applying voltage to the cathode layer 40 relative to the anode layer 20.

Hereinafter, the potential of a specific site of the cathode layer 40 relative to the anode layer 20 is referred to as “representative site potential Vr”. The representative site potential Vr in the absence of the applied voltage is referred to as “representative site natural potential VrN”. The representative site potential Vr in the presence of the applied voltage is referred to as “representative site forced potential VrF”.

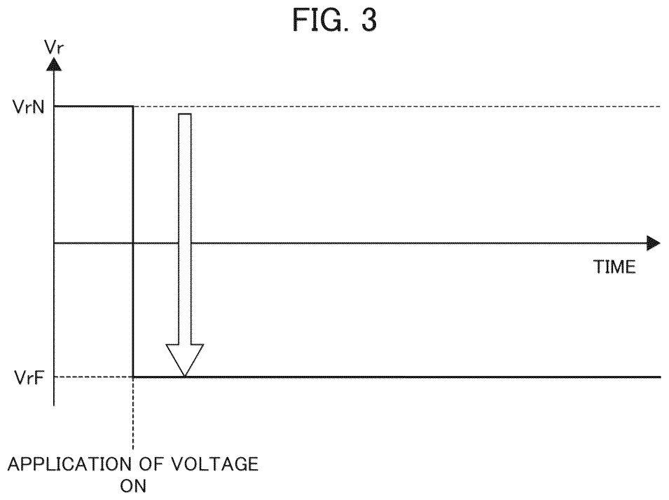

In this configuration, the controller 88 turns on the voltage application by the potential scanning circuit 83 to maintain cathode layer 40 at a lower potential than in the absence of the voltage application. Specifically, upon the application of voltage being turned on, the representative site potential Vr drops from the representative site natural potential VrN to the representative site forced potential VrF as shown in FIG. 3. The representative site natural potential VrN is, for example, greater than or equal to 0.05 V and less than or equal to 0.20 V.

Some contaminants d that adhere to the platinum Pt are negatively charged. Forcibly setting the cathode layers 40 to a negative potential through the potential scanning circuit 83 makes it easy for the platinum Pt in the cathode layer 40 to be negatively charged. Consequently, the adhesive force between the platinum Pt and the contaminants d weakens, and thus the contaminants d easily detach from the platinum Pt.

The following describes the control to be performed by the controller 88. The controller 88 causes the anode side gas supply 82 shown in FIG. 2 to humidify the fuel gas Gh and supply the humidified fuel gas Gh to the anode side gas diffusion layer 22, and causes the cathode side gas supply 84 to humidify the inert gas Gn and supply the humidified inert gas Gn to the cathode side gas diffusion layer 42.

As a result, a proton pump operates. Specifically, the hydrogen molecules H₂ in the fuel gas Gh in the anode side gas diffusion layer 22 dissociates into hydrogen ions H⁺ in the anode side catalyst layer 25. Then, the hydrogen ions H⁺ flow into the anode side catalyst layer 25. At the same time the electrons e flow into the circuit 83c. It should be noted that this reaction is catalyzed by the platinum Pt. The hydrogen ions H⁺ generated in the anode side catalyst layer 25 pass through the electrolyte membrane 30 to move to the cathode side catalyst layer 45. Meanwhile, the electrons e flow from the anode layer 20 side to the cathode layer 40 side in the circuit 83c.

The hydrogen ions H⁺ that have moved to the cathode side catalyst layer 45 combine with the electrons e from the circuit 83c to form hydrogen molecules H₂. The hydrogen molecules H₂ diffuses into the cathode side gas diffusion layer 42. Water molecules H₂O move along with the movement of the hydrogen ions H⁺ caused by operation of the proton pump described above, wetting the cell. As a result, the resistance to the movement of the reactants is reduced, and thus the fuel battery cell 50 is activated.

At the same time, the water molecules H₂O, which move along with the hydrogen ions H⁺ caused by operation of the proton pump, wash away the contaminants d suspended after having detached from the platinum Pt due to the negative potential described above. As a result, the effective catalyst surface area of the Pt increases, allowing for further activation of the fuel battery cell 50, in addition to the activation of each fuel battery cell 50 by the wetting described above.

The following summarizes configurations and effects of the present embodiment.

Some contaminants d that adhere to the platinum Pt are negatively charged. According to the present embodiment, therefore, the controller 88 forcibly maintains the cathode layers 40 to a lower potential by causing the potential scanning circuit 83 shown in FIG. 2 to apply a voltage thereto so as to set the cathode layers 40 to a negative potential relative to the anode layers 20. This makes it easy for the platinum Pt in the cathode layers 40 to be negatively charged. As a result, the adhesive force between the platinum Pt and the contaminants d weakens, and thus the contaminants d easily detach from the platinum Pt.

As shown in FIG. 2, the fuel gas Gh and the non-oxidizing gas Gn are respectively supplied to the anode layers 20 and the cathode layers 40 in such a state, to cause proton pumps to operate. Water moves along with hydrogen ions caused by operation of the proton pumps to efficiently wash away the contaminants d that have been made less adhesive to the platinum Pt due to the negative potential described above. Thus, it is possible to efficiently activate the fuel battery cells 50.

As described above, according to the present embodiment, the cathode layers 40 are set to a negative potential relative to the anode layers 20 during operation of proton pumps, making it possible to efficiently activate the fuel battery cells 50.

Moreover, the inert gas Gn, rather than the oxidizing gas Go, is supplied to the cathode side gas diffusion layers 42. This configuration helps keep the power output of the fuel battery cells 50 at a low level compared to a configuration in which the oxidizing gas Go is supplied to the cathode side gas diffusion layers 42. As such, the present embodiment does not require costly equipment.

### EXPLANATION OF REFERENCE NUMERALS

20: Anode layer
30: Electrolyte membrane
40: Cathode layer
50: Fuel battery cell
80: Fuel cell activation apparatus
82: Anode side gas supply
83: Potential scanning circuit
84: Cathode side gas supply
88: Controller
Gh: Fuel gas
Gn: Inert gas
Pt: Platinum

What is claimed is:

1. A fuel cell activation apparatus for activating a fuel battery cell including an anode layer, an electrolyte membrane, and a cathode layer in order from one side, the anode layer and the cathode layer containing platinum as a catalyst, the fuel cell activation apparatus comprising:
a potential scanning circuit configured to apply a voltage to the fuel battery cell;
an anode side gas supply configured to supply a fuel gas as a gas containing hydrogen to the anode layer;
a cathode side gas supply configured to supply an inert gas as a gas containing nitrogen and not containing oxygen to the cathode layer; and
a controller configured to control the potential scanning circuit, the anode side gas supply, and the cathode side gas supply, wherein
the controller causes the anode side gas supply to supply the fuel gas to the anode layer and causes the cathode side gas supply to supply the inert gas to the cathode layer, while setting the cathode layer to a negative potential relative to the anode layer through the potential scanning circuit to maintain the cathode layer at a lower potential than when the controller does not set the cathode layer to a negative potential relative to the anode layer.
